(19) United States
(12) Patent Application Publication
(10) Pub. No.: US 2025/0342315 A1
(43) Pub. Date: Nov. 6, 2025

(54) UNIVERSAL TIME SERIES TOKENS FOR TRAINING LARGE LANGUAGE MODELS FOR TIME SERIES FORECASTING

(71) Applicant: International Business Machines Corporation, Armonk, NY (US)

(72) Inventors: Mehdi Azabou, Atlanta, GA (US); Nam H. Nguyen, Pleasantville, NY (US); Chandrasekhara K. Reddy, Kinnelon, NJ (US); Kyong Min Yeo, Scarsdale, NY (US); Jayant R. Kalagnanam, Briarcliff Manor, NY (US)

(21) Appl. No.: 18/654,175

(22) Filed: May 3, 2024

(51) Int. Cl. G06F 40/284; G06F 16/383

(52) U.S. Cl. CPC G06F 40/284; G06F 16/383

(57) ABSTRACT

Systems and techniques that facilitate building a universal vocabulary of tokens from time series for training large language models are provided. For example, one or more embodiments described herein can comprise a computer system for facilitating a process to build a universal vocabulary of tokens from time series for large language model training, which can comprise one or more processors, one or more computer readable storage media, and program instructions stored on the one or more computer readable storage media, the program instructions executable by the processor resulting in the computer system to perform one or more functions, the functions comprising segmenting one or more time series based on local minima of the one or more time series. The functions can further comprise generating a universal vocabulary of tokens.

### BACKGROUND

The subject disclosure relates to time series tokenization, and more specifically, to building universal time series tokens for training sequential, auto-regressive models typically used for training a large language model (LLM), such as generative pre-trained transformer (GPT), for time series forecasting. Such models are henceforth referred to as LLMts.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate text segmentation and automatic speech recognition capitalization and punctuation are provided.

According to an embodiment, a computer system for facilitating a process to build a universal vocabulary of tokens from time series for large language model training can comprise one or more processors, one or more computer readable storage media, and program instructions stored on the one or more computer readable storage media, the program instructions executable by the processor resulting in the computer system to perform one or more functions, the functions comprising: segment one or more time series based on local minima of the one or more time series; and generate a universal vocabulary of tokens.

According to another embodiment, a computer-implemented method for facilitating a process to build a universal vocabulary of tokens from time series for large language model training can comprise segmenting, by a processor, one or more time series based on local minima of the one or more time series; and generating, by the processor, a universal vocabulary of tokens.

According to another embodiment, a computer program product comprising a computer readable storage medium having program instructions embodied therewith, the program instructions executable by a processor to cause the processor to segment, by the processor, one or more time series based on local minima of the one or more time series; and generate, by the processor, a universal vocabulary of tokens.

### DESCRIPTION OF THE DRAWINGS

FIG. 1 illustrates a block diagram of an example, non-limiting system that can facilitate universal tokenization of time series for LLMts training in accordance with one or more embodiments described herein.

FIG. 2 illustrates a block diagram of an example, non-limiting component that can facilitate universal tokenization of time series for LLMts training in accordance with one or more embodiments described herein.

FIG. 3 illustrates a block diagram of an example, non-limiting system that can facilitate universal tokenization of time series for LLMts training in accordance with one or more embodiments described herein.

FIG. 4 illustrates an example diagram of segmenting time series without length constraints in accordance with one or more embodiments described herein.

FIG. 5 illustrates an example diagram of normalizing tokens by extracting vertical or horizontal scales in accordance with one or more embodiments described herein.

FIG. 6 illustrates an example diagram of parameterizing tokens based on a continuous basis function in accordance with one or more embodiments described herein.

FIG. 7 illustrates an example diagram of generating embeddings from time series tokens for training an LLMts in accordance with one or more embodiments described herein.

FIG. 8 illustrates an example diagram of training an LLMts on embeddings of time series tokens and a token embedding space visualization in accordance with one or more embodiments described herein.

FIG. 9 illustrates an example diagram of training an LLMts for multi-variate time series forecasting in accordance with one or more embodiments described herein.

FIG. 10 illustrates a diagram of the forecasting performance of an LLMts trained on time series tokens in accordance with one or more embodiments described herein.

FIG. 11 illustrates a diagram of the forecasting performance of an LLMts trained on time series tokens in accordance with one or more embodiments described herein.

FIG. 12 illustrates a diagram of the forecasting performance of an LLMts trained on time series tokens in accordance with one or more embodiments described herein.

FIG. 13 illustrates a flow diagram of an example, non-limiting, computer implemented method that facilitates universal tokenization of time series for LLMts training in accordance with one or more embodiments described herein.

FIG. 14 illustrates an example, a non-limiting environment for the execution of at least some of the computer code in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

LLMts are typically deep learning models trained on large datasets comprising billions or trillions of words, for example. LLMts learn and understand large-scale natural language data, thereby greatly improving productivity for individuals. Such architectures can typically comprise transformer-based architectures and can process sequential data such as text. However, LLMts cannot be trained on time series data due to heterogeneity of time series across different domains. Currently, tokenization of time series to enable LLMts training consists of patching (e.g., dividing the time series into smaller, overlapping or non-overlapping segments, often referred to as patches), which is inflexible to diverse time series. For example, patching can lead to a loss of temporal context in a time series and can cause gaps between datasets, proving difficult to use for training an LLMts. Additionally, patching can be sensitive to shifts (e.g., shift window of time by one or more points) or changes in sampling rates because alterations in temporal resolution can disrupt alignment of patches, leading to inconsistencies in representation of temporal patterns. For example, if patches are changed due to a change in sampling rate, the LLMts may fail to generalize because the amount of information encoded in each patch has changed. As another example, a shift can cause a completely new set of patches although most datapoints that are observed are still present, which can degrade the LLMts ability to generalize. Therefore, it can be desirable to train an LLMts that can be trained on any time series.

Furthermore, current tokenization methods comprise constraints on token lengths. In particular, tokens typically require a same length among all tokens, although an optimal token size may differ across different time series. Such a method can cause unequal representation of data points within each token due to variability in data density among time series, leading to biased LLMts conclusions. Additionally, equal segmentation of the data equally may not appropriately capture underlying data patterns within each time series, such as seasonality or trends. Moreover, a time series may contain significantly more or fewer data points compared to other time series, and equal segmentation of the time series can exaggerate data imbalances. Thus, current tokenization methods of time series for LLMts training can involve extensive computations and memory storage requirements for training data.

In view of the problems discussed above, the present disclosure can be implemented to produce a solution to one or more of these problems by segmenting, by a system operatively coupled to a processor, one or more time series based on local minima of the one or more time series to generate tokens; and generating, by the system, a universal vocabulary of tokens for training a large language model on the one or more time series by normalizing and parameterizing the tokens. By segmenting the time series based on local minima, the tokens can comprise their respective optimal token length by comprising any suitable length that enables the LLMts to capture different underlying patters within each time series, and thereby improving the generalization of the LLMts. Further, by normalizing and parameterizing the tokens, the tokens can comprise a uniform dimensionality among time series that enable generation of embeddings to train the LLMts. This overcomes the heterogeneity of time series that prevents reliable training of an LLMts on time series. In other words, a universal vocabulary of tokens can be created from many diverse time series to be utilized to train an LLMts. Accordingly, the present disclosure provides a universal tokenization process that addresses the problems related to time series tokenization for LLMts training.

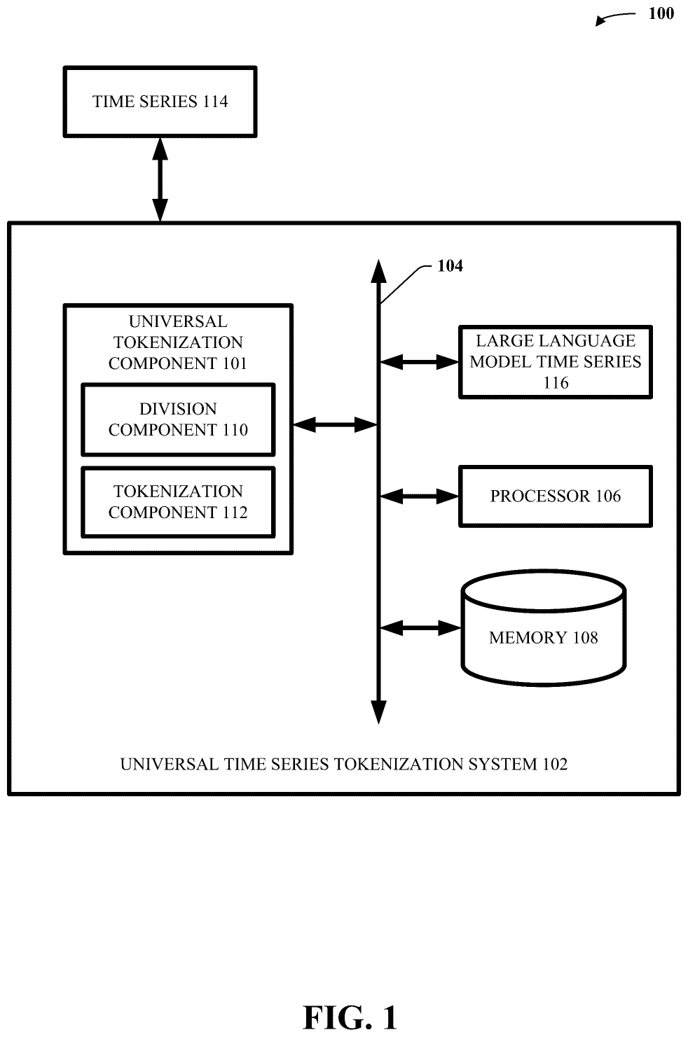

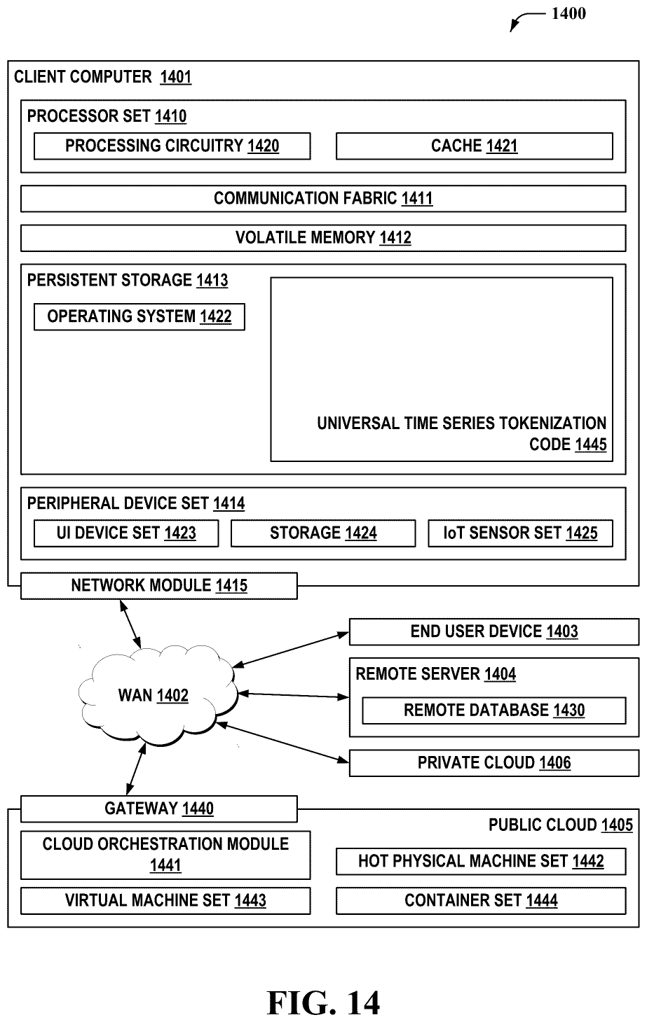

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1400 illustrated at FIG. 14. For example, non-limiting system 100 can be associated with, such as accessible via, a computing environment 1400 described below with reference to FIG. 14, such that aspects of processing can be distributed between non-limiting system 100 and the computing environment 1400. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can facilitate universal tokenization of time series for LLMts training in accordance with one or more embodiments described herein.

Non-limiting system 100 and/or the components of non-limiting system 100 can be employed to use hardware and/or software to solve problems that are highly technical in nature (e.g., related to machine learning, time series tokenization, etc.), that are not abstract and that cannot be performed as a set of mental acts by a human. Further, some of the processes performed may be performed by specialized computers to carry out defined tasks related to the universal tokenization of time series for LLMts training. Non-limiting system 100 and/or components of non-limiting system 100 can be employed to solve new problems that arise through advancements in technologies mentioned above and/or the like. Non-limiting system 100 can provide technical improvements to machine learning systems by increasing reducing computer storage requirements for training sets and providing improved and more efficient. For example, embodiments disclosed herein can be beneficial for LLMts training.

Non-limiting system 100 can comprise universal time series tokenization system 102. Discussion turns briefly to processor 106, memory 108 and bus 104 of system 102. For example, in one or more embodiments, system 102 can comprise processor 106 (e.g., computer processing unit, microprocessor, classical processor, and/or like processor). In one or more embodiments, a component associated with system 102, as described herein with or without reference to the one or more figures of the one or more embodiments, can comprise one or more computer and/or machine readable, writable and/or executable components and/or instructions that can be executed by processor 106 to enable performance of one or more processes defined by such component(s) and/or instruction(s).

In one or more embodiments, system 102 can comprise a computer-readable memory (e.g., memory 108) that can be operably connected to processor 106. Memory 108 can store computer-executable instructions that, upon execution by processor 106, can cause processor 106 and/or one or more other components of system 102 (e.g., universal tokenization component 101, division component 110, tokenization component 112, and/or LLMts 116) to perform one or more actions. In one or more embodiments, memory 108 can store computer-executable components (e.g., universal tokenization component 101, division component 110, tokenization component 112, and/or LLMts 116).

System 102 and/or a component thereof as described herein, can be communicatively, electrically, operatively, optically and/or otherwise coupled to one another via bus 104. Bus 104 can comprise one or more of a memory bus, memory controller, peripheral bus, external bus, local bus, and/or another type of bus that can employ one or more bus architectures. One or more of these examples of bus 104 can be employed. In one or more embodiments, system 102 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 102 can reside in the cloud, and/or can reside locally in a local computing environment (e.g., at a specified location(s)).

In various embodiments, the universal tokenization component 101 can comprise sub-components (e.g., division component 110, tokenization component 112). The sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In one or more embodiments, there can be time series 114. In various aspects, the time series 114 can comprise one or more time series datasets. In some instances, the time series 114 can be heterogenous. More specifically, each time series dataset of the time series 114 can comprise different characteristics (e.g., temporal scales, dynamics, resolutions, data source or domain, sampling frequency, seasonality, data quality). For example, a time series of the time series 114 can comprise a different temporal scale than another time series of the time series 114 (e.g., the time series consists of temperature measurements recorded every hour and the other time series consists of temperature measurements recorded every six hours). As another example, a time series of the time series 114 can be of a different domain than another time series of the time series 114 (e.g., the time series consists of stock prices of companies traded on the stock market and the other time series consists of traffic volume measurements on a highway). As yet another example, a time series of the time series 114 can comprise a different temporal pattern than another time series of the time series 114 (e.g., the time series consists of total sales revenue of retail stores that exhibit seasonal patterns corresponding to holidays and the other time series consists of counts of social media interactions that exhibit seasonal patterns corresponding to marketing events).

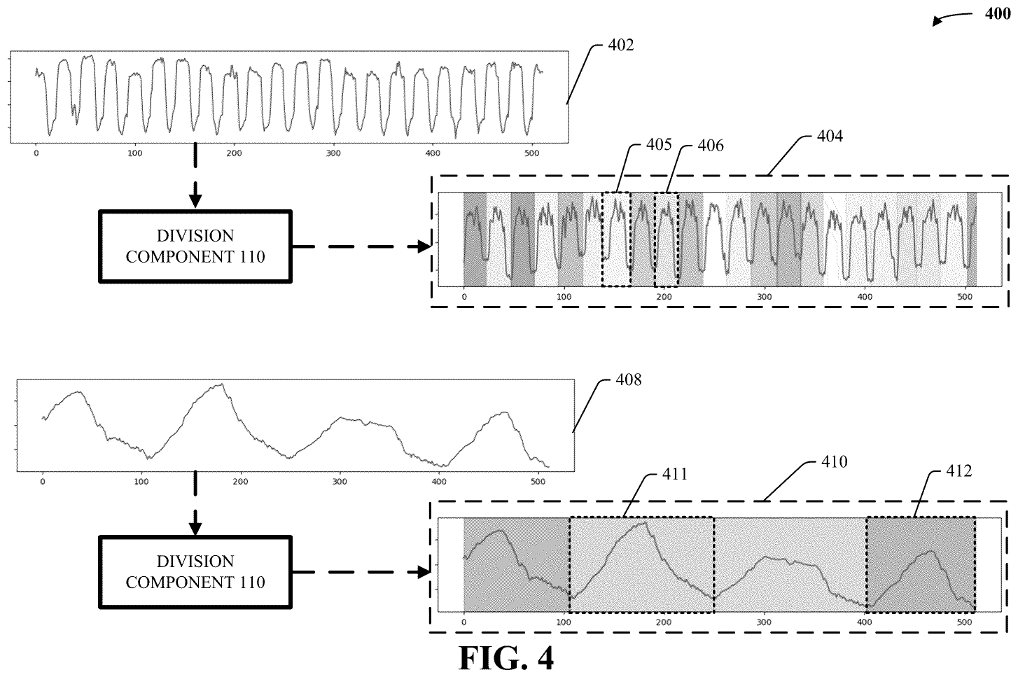

In any case, the division component 110 can access the time series 114 and segment each time series of the time series 114. More specifically, the division component 110 can segment each time series of the time series 114 based on a geometric feature such as local minima of the respective time series. In other words, the division component 110 can sub-divide each of the time series 114 into a series of tokens (e.g., segments) based on the geometric feature. In various cases, segmentation of the time series 114 based on the geometric feature can enable tokens to be of variable length with no constraints on the length of each of the tokens. Various non-limiting aspects are described with respect to FIG. 4.

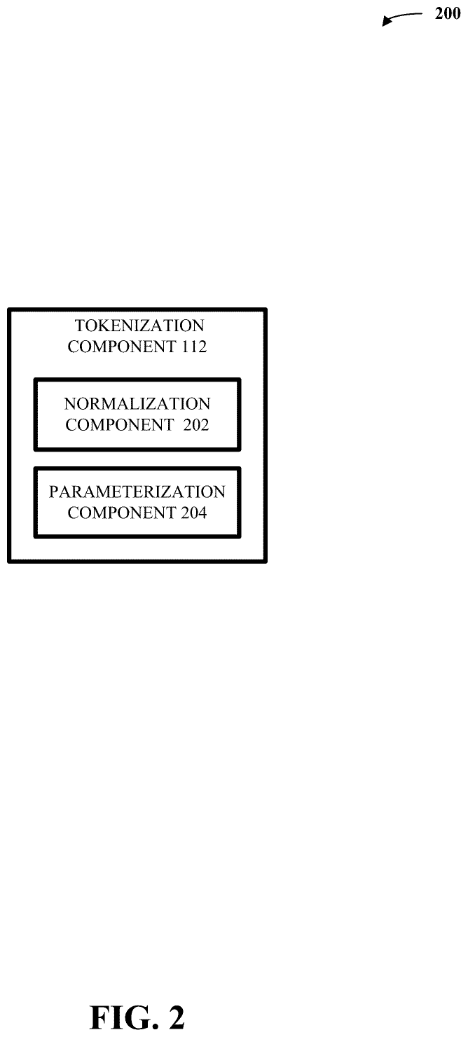

In various embodiments, the tokenization component 112 can access the tokens generated for each of the time series 114. In various aspects, the tokenization component 112 can normalize and parameterize the tokens to address the heterogeneity of the time series 114, and therefore enable the tokens to be utilized for training the LLMts 116 on the time series 114. Various non-limiting aspects are described with respect to FIGS. 2, 5, and 6.

In various embodiments, the LLMts 116 can comprise any suitable architecture. In one or more embodiments, LLMts 116 can be trained on time series 114 by the methods described herein. Typically, LLMts or other foundation models can't be trained on time series data. However, these methods can be applied to LLMts or other foundation models due to the specialized tokenization process described herein. In one or more embodiments, the training criteria can comprise an amount of training time, an accuracy rating, a number of training cycles, a set amount of training data, and/or another metric used to determine when training is complete.

FIG. 2 illustrates a block diagram of an example, non-limiting component 200 that can facilitate universal tokenization of time series for LLMts training in accordance with one or more embodiments described herein.

In various embodiments, the tokenization component 112 can comprise a normalization component 202. In various aspects, the normalization component 202 can normalize the tokens generated by the division component 110 of the time series 114. In various instances, normalizing the tokens can comprise extracting a plurality of vertical and horizontal scales from the tokens. In other words, the normalization component 202 can encode the tokens by extracting the dimension of the tokens, where the width corresponds to the number of points in the token and the height corresponds to the amplitude of the token. The normalization component 202 can extract the horizontal and vertical scales by applying a scaling operation to enforce uniformity in dimensions across the tokens (e.g., resizing the tokens to uniform width and height). After extracting the horizontal and vertical scales to enforce uniform dimensions, a residual of each of the tokens can remain. Various non-limiting aspects are described with respect to FIG. 4.

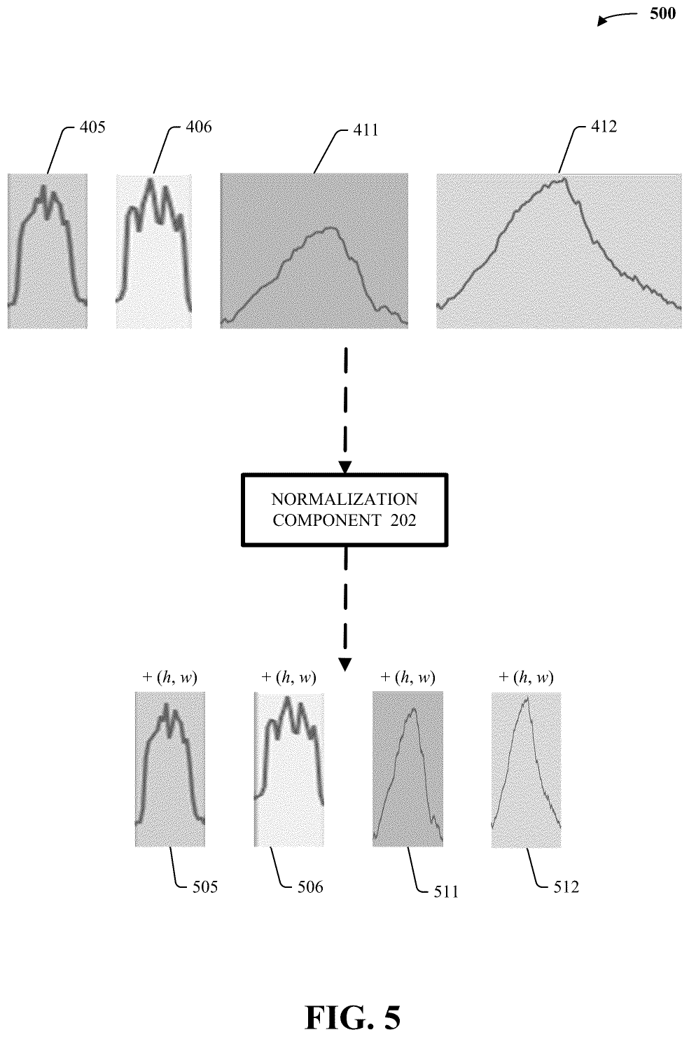

In various embodiments, the tokenization component 112 can comprise a parameterization component 204. In various aspects, the parameterization component 204 can parameterize the normalized tokens and the residuals of the respective normalized tokens to address the variable number of data points within each of the tokens. In various instances, parameterizing the normalized tokens can comprise approximating the normalized tokens with a continuous basis function. In various cases, any suitable continuous basis function can be employed to approximate the normalized tokens. For example, the continuous basis function can be, but is not limited to, Legendre Polynomials, Chebyshev Polynomials, Hermite Polynomials, Bernstein Polynomials, trigonometric functions, or wavelets. Various non-limiting aspects are described with respect to FIG. 5.

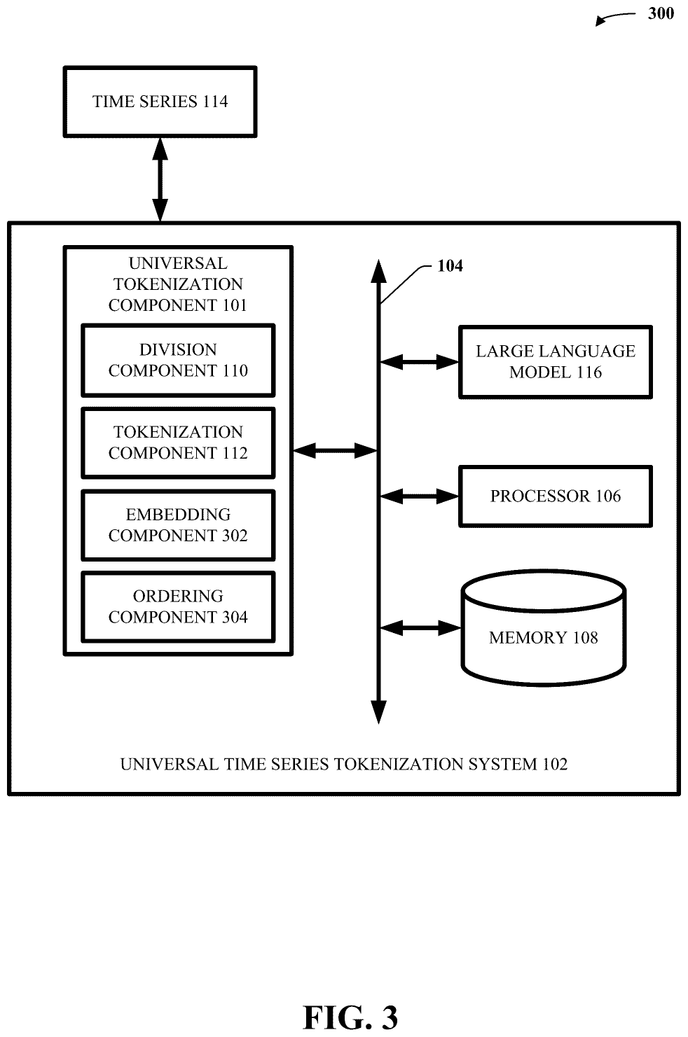

FIG. 3 illustrates a block diagram of an example, non-limiting system 300 that can facilitate universal tokenization of time series for LLMts training in accordance with one or more embodiments described herein. As shown, the system 300 can comprise the same components as the system 100, and can, in some cases, further comprise an embedding component 302 and an ordering component 304.

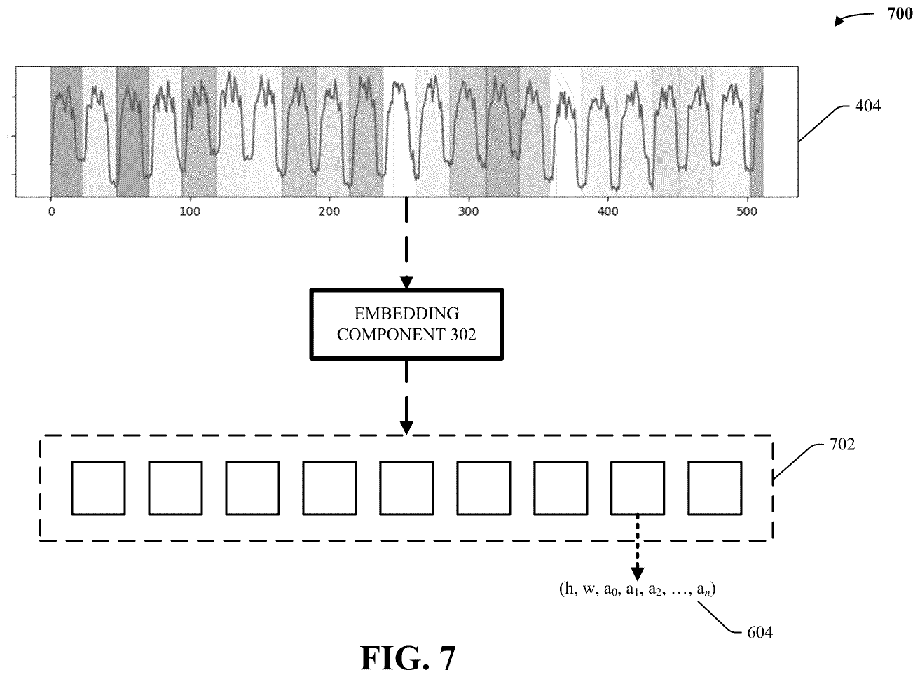

In various embodiments, the embedding component 302 can generate embeddings of the normalized and parameterized tokens. In various aspects, the embeddings can be of K dimensions. More specifically, if a time series comprises N datapoints (e.g., [x₁, . . . , x_{N}]), the embedding component 302 generates a sequence of L tokens, each of K dimensions (e.g., [t₁, . . . , t_{L}]). Such mapping can be defined by [symbol] [symbol] [symbol] , [x₁, . . . , x_{N}]→[t₁, . . . , t_{L}]. Various non-limiting aspects are describe with respect to FIGS. 7-9. In various aspects, the embeddings can be fed into the LLMts 116 to train the LLMts 116 on the time series 114. Thus, the LLMts 116 can be trained on time series of different resolutions, temporal scales, dynamics, domains, etc.

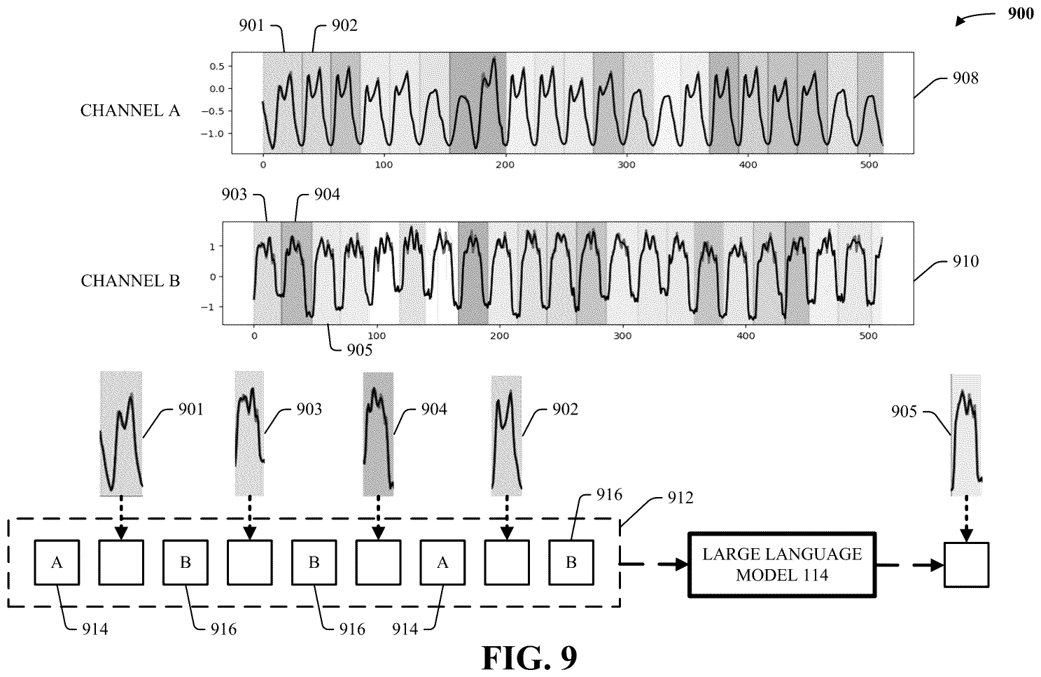

In various embodiments, the ordering component 304 can sort the tokens based on a respective timestamp of the tokens when the time series is multi-variate and consists of multiple channels. In various aspects, the embeddings generated by the tokens can then be input as training data into LLMts 116 in the sorted order of the tokens based on the timestamps. Various non-limiting aspects are described with respect to FIG. 9.

FIG. 4 illustrates an example diagram 400 of segmenting time series without length constraints in accordance with one or more embodiments described herein.

In various embodiments, the time series 114 can comprise, as an example, a time series 402 and a time series 408. As shown, the time series 402 and the time series 408 exhibit different temporal resolutions and dynamics (e.g., different seasonality). In various instances, the division component 110 can receive the time series 402. In various cases, the division component 110 can output, in response to receiving time series 402, a series of tokens 404. The division component 110 can determine the tokens 404 based on local minima of the time series 402.

In various instances, any suitable method to determine the local minima of the time series 402 can be employed. For example, the division component 110 can employ, but is not limited to, peak detection algorithms, derivative-based methods, window-based techniques, thresholding, local extrema search, mathematical morphology, machine learning approaches, or Fourier transform.

The tokens 404 can contain a segment of data points of the time series 402. In various aspects, each of the tokens 404 do not need to comprise the same number of datapoints. In other words, each of the tokens 404 can comprise a variable number of datapoints (e.g., comprise a variable length). For example, token 405 can comprise more datapoints than token 406.

In various embodiments, the division component 110 can also receive the time series 408. In various cases, the division component 110 can output, in response to receiving time series 408, a series of tokens 410. The division component 110 can determine the tokens 410 based on local minima of the time series 408. As shown, the tokens 410 can comprise a different number of datapoints within each token. For instance, token 411 can comprise more datapoints than token 412.

Furthermore, each of the time series 114 can be divided into any suitable number of tokens. In other words, each of the time series 114 can be segmented into a different number of tokens. For example, time series 402 is segmented into 20 tokens and time series 408 is segmented into 4 tokens.

FIG. 5 illustrates an example diagram 500 of normalizing tokens by extracting vertical or horizontal scales in accordance with one or more embodiments described herein.

In various embodiments, the normalization component 202 can receive one or more tokens. For example, the normalization component 202 can receive tokens 404 and tokens 410. In particular, for mere purpose of example, the normalization component 202 can receive token 405, token 406, token 411, and token 412. As shown, token 405, token 406, token 411, and token 412 can comprise differing widths and heights. In response to receiving token 405, token 406, token 411, and token 412, the normalization component 202 can generate normalized token 505, normalized token 506, normalized token 511, and normalized token 512 respectively, that share a uniform dimensionality. More specifically, the normalized tokens can share the same width and height. In various aspects, each of the normalized tokens can contain a residual height and a residual width. In other words, the residual can represent the difference between the original token (e.g., 405, 406, 411, 412) and its normalized form (e.g., 505, 506, 511, 512). The residual height of each normalized token can be denoted by h and the residual width of each token can be denoted by w.

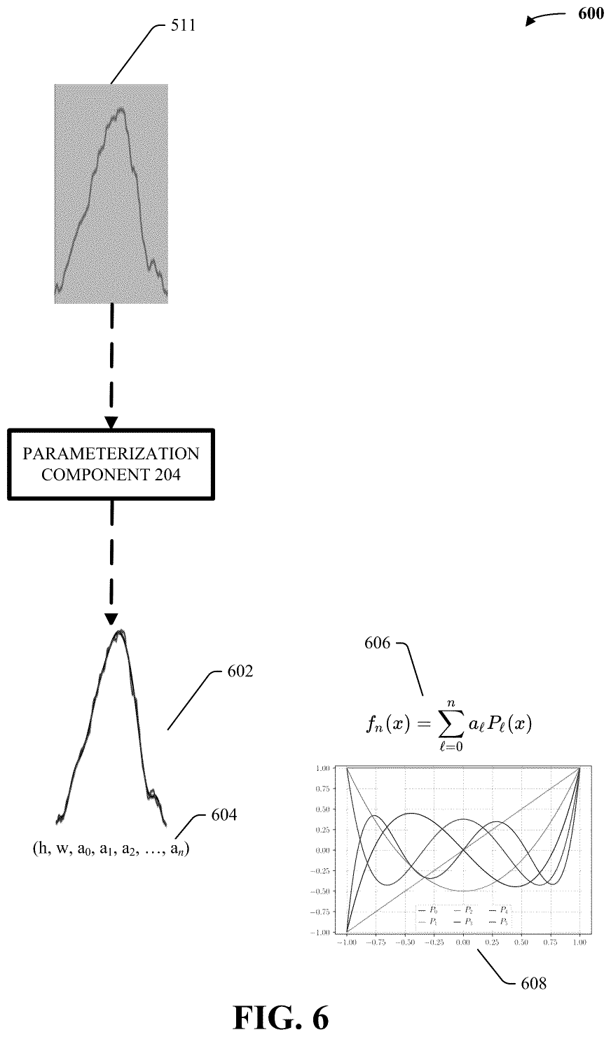

FIG. 6 illustrates an example diagram 600 of parameterizing tokens based on a continuous basis function in accordance with one or more embodiments described herein.

In various embodiments, the parameterization component 204 can receive one or more tokens. In various instances, the tokens can be normalized (e.g., via normalization component 202) prior to the parameterization component receiving the tokens. In various aspects, the parameterization component 204 can generate an approximated token approximated by a continuous basis function. As used herein, Legendre Polynomial is used as the continuous basis function, however, any other suitable continuous basis function can be used to parameterize the tokens. Legendre Polynomials can be defined by equation 606, where graph 608 depicts the first six Legendre Polynomials (e.g., P₀, . . . , P₅). As an example, the parameterization component 204 can receive normalized token 511, and in response, generate a parameterized token 602. The parameterized token 602 can comprise any suitable number of coefficients (e.g., a₀, . . . , aₙ) based on the dimension or degree of the time series 114. In any case, the coefficients can be fixed for all tokens. Accordingly, the parameterized token 602 can comprise the any suitable number of coefficients, the residual height h, and the residual width w as parameters 604 for approximating token 511. In various aspects, the parameters 604 can be considered as expressing the shape, horizontal scale, and vertical scale of the token 511. As an example, in the case of Legendre Polynomials and the dimension n=16, the parameterized tokens will comprise 18 parameters (e.g., h, w, and a₀, . . . , a₁₅). Therefore, all tokens can comprise the same dimensionality.

In various instances, the number of coefficients chosen to approximate the token 511 can be based on characteristics of the time series 114 or an error resulting from the continuous basis function. For example, Legendre Polynomials can result in a reconstruction error that may increase if the order of the Legendre Polynomials decreases. Therefore, depending on types of frequency or noise of the time series 114, the number of coefficients can be adapted to reduce the reconstruction error to a desired amount. In some cases, the parameterization component 204 can denoise the time series 114 through approximation by the continuous basis function. For instance, such an approximation can omit or skip outlier data points.

FIG. 7 illustrates an example diagram 700 of generating embeddings from time series tokens for training an LLMts in accordance with one or more embodiments described herein.

In various embodiments, the embedding component 302 can receive one or more sequences of tokens. For instance, the embedding component 302 can receive tokens 404. In various instances, the tokens 404 can undergo normalization and parameterization prior to the embedding component 302 receiving the tokens 404. In various aspects, the embedding component 302 can generate, in response to receiving tokens 404, embeddings 702 of the tokens 404. In various instances, the embedding component 302 can generate an embedding for each token of the tokens 404. More specifically, there can be L tokens generated, each of dimension K, wherein K can be defined by the number of parameters 604 used to generate the parameterized tokens. The embeddings 702 can then be input into LLMts 116 to enable training of the LLMts 116 on the time series 402 (e.g., or any time series of time series 114).

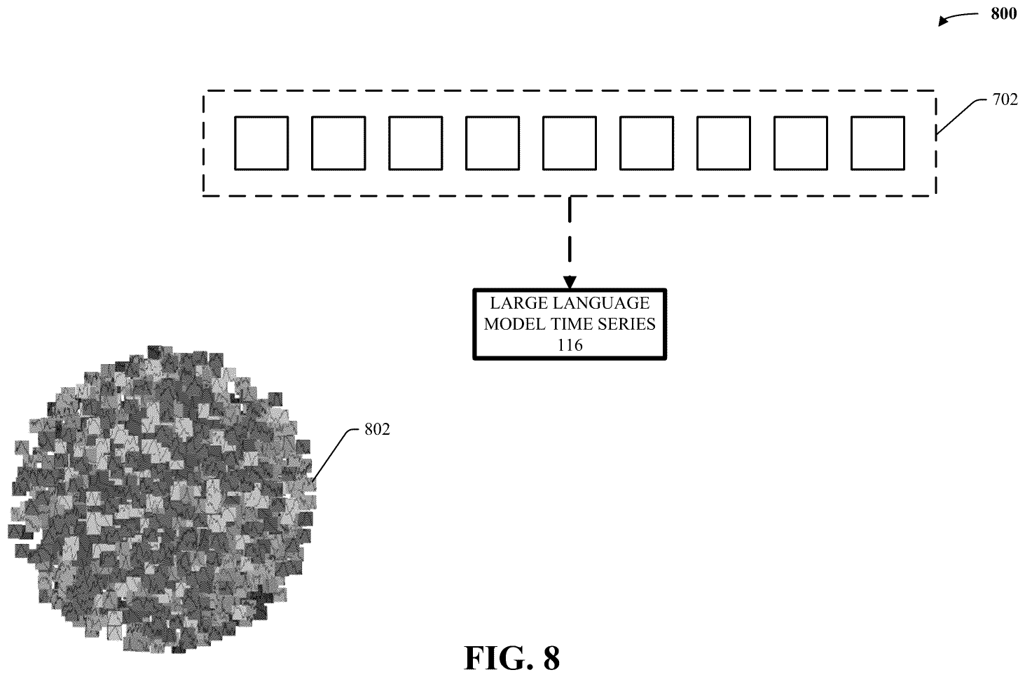

FIG. 8 illustrates an example diagram 800 of training an LLMts on embeddings of time series tokens and a token embedding space visualization in accordance with one or more embodiments described herein.

In various aspects, the tokens generated, after normalization and parameterization, of each time series of the time series 114 can be considered as the universal vocabulary of tokens. Visualization 802 depicts a token embedding space of a universal vocabulary of tokens generated by tokenizing, via methods described in the present disclosure, nine benchmark time series datasets comprising different characteristics in a K-dimensional space. As shown, the token embedding space does not exhibit clustering of the tokens (e.g., separate clustering of the datasets), suggesting the nine benchmark time series datasets share similar “words” (e.g., tokens). In such cases where the time series 114 exhibit similar “words” after universal tokenization, it can be desirable to train the LLMts 116 on the time series 114 by inputting embeddings 702 of the tokens generated of time series 114 into LLMts 116 as training data. In various instances, leveraging such similarities identified through universal tokenization by training the LLMts 116 on the time series 114 can facilitate development of a more robust and effective model for time series analysis tasks such as forecasting, anomaly detection, or classification. As an example, the LLMts 116 can be trained on the embeddings 702 to predict a next “word” (e.g., token), wherein the embeddings 702 represent 16,000 tokens generated from nine benchmark time series datasets with approximately 500 channels. Note that, in any case (e.g., the time series 114 do not exhibit similar “words”), the LLMts 116 can still be trained on the time series 114 by inputting embeddings 702 of the tokens generated of time series 114 into LLMts 116 as training data. By normalizing and parameterizing the tokens of the time series to comprise a uniform dimensionality, embedding component 302 can generate embeddings of the tokens to train the LLMts 116 to predict tokens, thereby overcoming a shortcoming of existing LLMts training, and enabling LLMts to be trained on time series.

FIG. 9 illustrates an example diagram 900 of training an LLMts for multi-variate time series forecasting in accordance with one or more embodiments described herein.

In various embodiments, the universal tokenization component 101 can also tokenize and embed multi-variate (e.g., the time series data is organized into different channels) time series. For instance, if a time series of the time series 114 is multivariate, the embedding component 302 can generate embeddings 912 for tokens 908 of a first channel and for tokens 910 of a second channel (e.g., channel A and channel B respectively). In various aspects, the embedding component 302 can determine a channel identification token that corresponds to the first channel and another channel identification token that corresponds to the second channel.

In various instances, there can be any suitable number of different channels for a multi-variate time series. In any case, the embedding component 302 can generate an embedding of a channel identification token for each channel. The embedding of the channel identification tokens can comprise any suitable format. For example, the embeddings of the channel identification tokens can be a positional embedding depending on the total number of channels.

In various embodiments, the ordering component 304 can sort the tokens 908 and the tokens 910 based on a timestamp of the tokens. In particular, the ordering component 304 can sort the tokens 908 and the tokens 910 into sequential order based on a starting timestamp of each token. For example, by order of starting timestamps, the ordering component 304 can determine the sorted order to be token 901, token 903, token 904, and token 902.

In various embodiments, the embedding component 302 can then pre-append (e.g., label) an embedding of a channel identification token to each embedding of a token in the sorted order determined by the ordering component 304. For instance, the embedding component 302 can generate embedding 914 to identify the first channel and embedding 916 to identify the second channel. Accordingly, the embedding component 302 can pre-append embedding 914 to an embedding of token 901 and to an embedding of token 904. Similarly, the embedding component 302 can pre-append embedding 916 to an embedding of token 903 and to an embedding of token 902. In various embodiments, the embeddings of the tokens after pre-appending the channel identification tokens can be fed into the LLMts 116 as training data in the order determined by ordering component 304. Furthermore, the LLMts 116 can, in response to receiving the embeddings 912, generate a prediction of the following token. For instance, LLMts 116 can generate a prediction of token 905. In various cases, an embedding of a channel identification token can also be appended to the end of the embeddings to identify the channel from which the LLMts 116 is predicting the next token. For instance, embedding 916 is appended to embeddings 912 to identify the second channel for predicting token 905. In various instances, the embedding component 302 can generate the embeddings 912 as orthogonal random features (ORF). ORFs are a class of features used in machine learning constructed by generating random vectors with specific properties, particularly orthogonality.

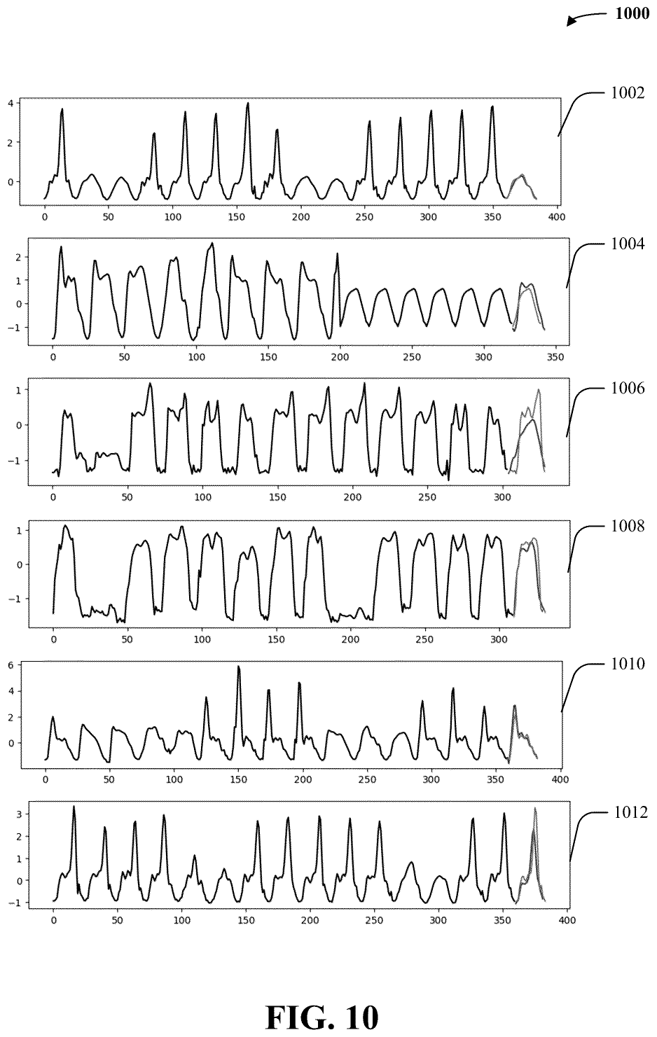

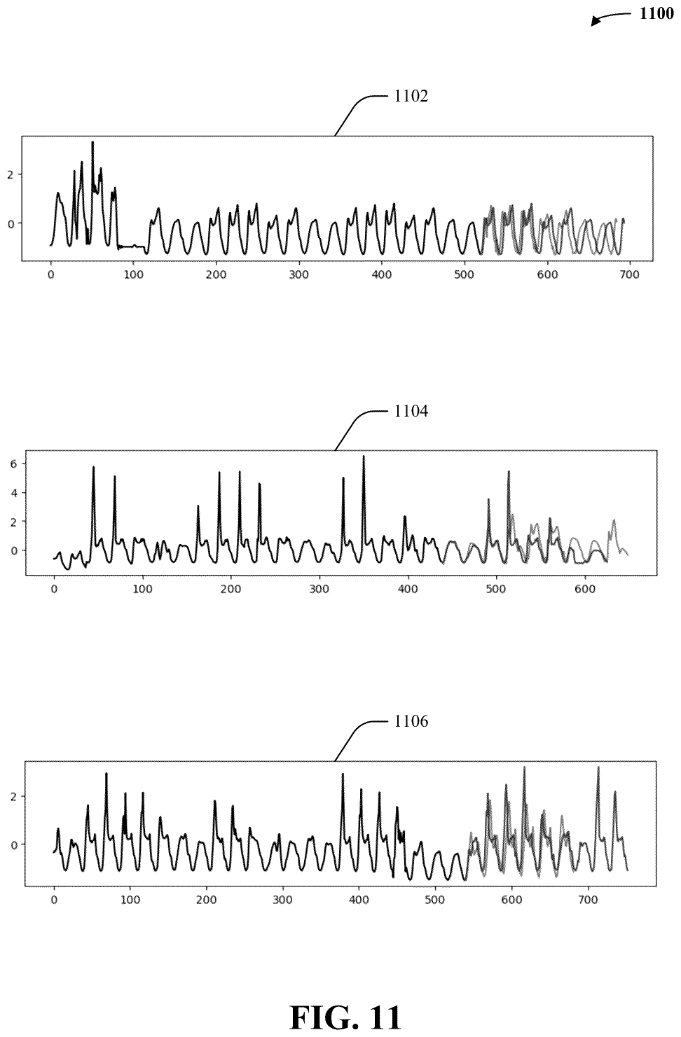

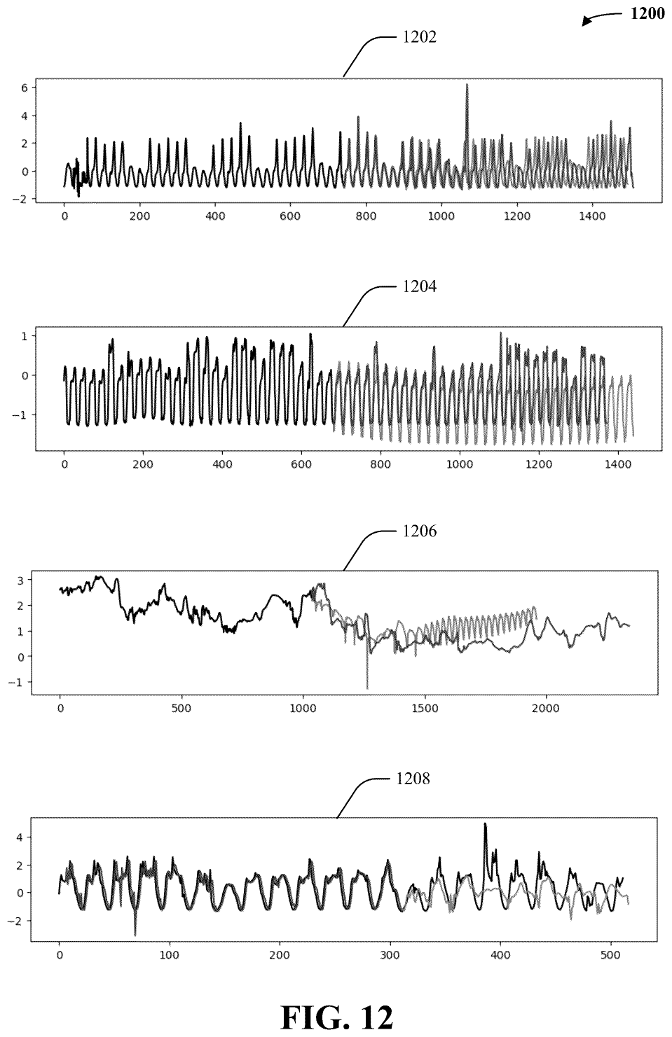

FIGS. 10-12 illustrate diagrams 1000, 1100, and 1200 of the forecasting performance of an LLMts trained on time series tokens in accordance with one or more embodiments described herein.

To determine performance of an LLMts trained on time series, LLMts 116 is trained in accordance with one or more embodiments described herein and on various time series datasets originating from different domains and data sources. The LLMts 116 comprises a decoder-only transformer architecture. The last tokens of each of the time series datasets are withheld from the training data. Depicted in graphs 1002, 1004, 1006, 1008, 1010, and 1012 are time series and the LLMts predicted token compared to the actual token. As shown, the LLMts 116 trained on the various time series datasets as described herein exhibits little deviation from the tokens of which it is predicting, thus exhibiting enhanced generalization capabilities to data from different domains and data sources.

Graphs 1102, 1104, 1106, 1202, 1204, and 1206 depict performance of LLMts 116 wherein the LLMts 116 is utilized in an autoregressive fashion (e.g., modeling approach where the prediction of a variable at a given time step is based on its previous values). As shown, the LLMts 116 trained on the various time series datasets as described herein exhibits little deviation from the tokens of which it is predicting, particularly in near future predictions, thus exhibiting enhanced generalization and forecasting capabilities.

In various aspects, the methods described herein can further allow the LLMts 116 to be tested on unseen datasets. Graph 1208 depicts performance of LLMts 116 in a zero-shot learning setting (e.g., tested on a dataset that was seen during training). The LLMts 116 was trained on Electricity Transformer Temperatures (ETT) and tested on a traffic dataset that was unseen during training. As shown, even in a zero-shot learning setting, (e.g., without further training the LLMts 116 on the traffic dataset), the LLMts 116 demonstrates accurate predictions of the traffic dataset in near future predictions, thereby exhibiting enhanced generalization capabilities to diverse datasets with little training.

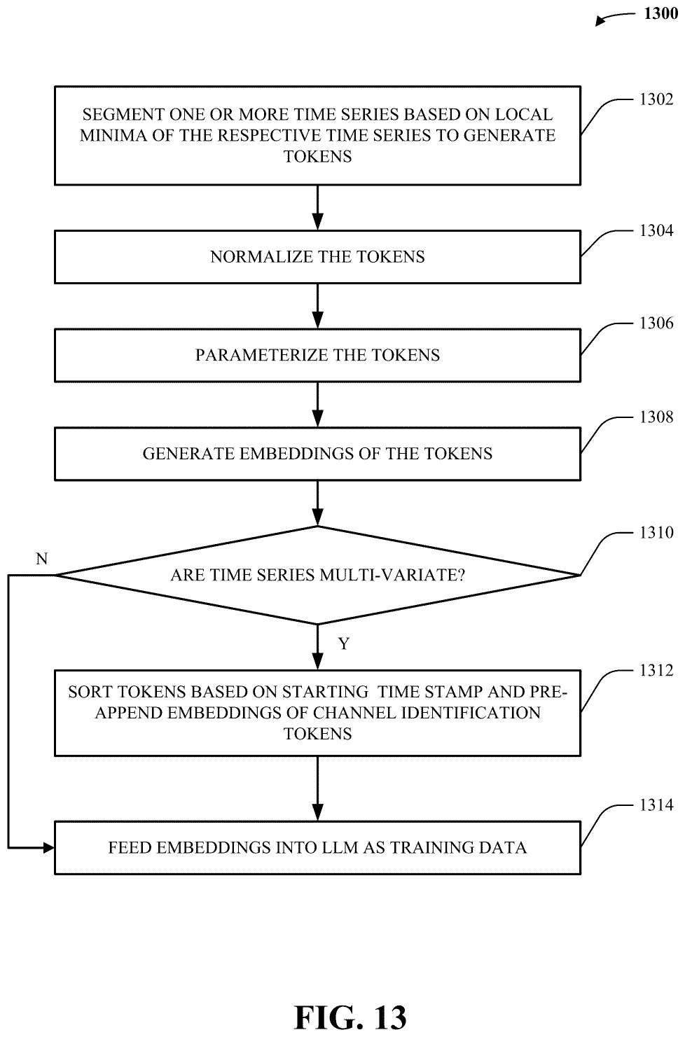

FIG. 13 illustrates a flow diagram of an example, non-limiting, computer implemented method 1300 that facilitates universal tokenization of time series for LLMts training in accordance with one or more embodiments described herein. Repetitive description of like elements employed in other embodiments described herein is omitted for sake of brevity.

At 1302, method 1300 can comprise segmenting, by a system (e.g., division component 110) operatively coupled to a processor (e.g., processor 106), one or more time series (e.g., 114) based on local minima of the respective time series to generate tokens. As described in greater detail above in reference to FIG. 4, division component 110 can produce a sequence of tokens for each of the one or more time series.

At 1304, method 1300 can comprise normalizing, by the system (e.g., normalization component 202) the tokens. For example, as described above in reference to FIG. 5, normalization component 202 can receive the tokens and extract horizontal and vertical scales from the tokens. More specifically, the normalization component 202 can perform a scaling operation to the tokens to enforce a uniform width and height among the tokens and compute residual amounts of the height and width for each token.

At 1306, method 1300 can comprise parameterizing, by the system (e.g., parameterization component 204) the tokens. For example, as described above in reference to FIG. 6, parameterization component 204 can receive the tokens after normalization and parameterize the tokens based on a continuous basis function. In other words, the parameterization component 204 can approximate the tokens using the continuous basis function to enforce a uniform dimensionality among the tokens. In various aspects, the parameters to approximate the tokens can comprise the residual amounts of the height and width for each token after normalization.

At 1308, method 1300 can comprise generating, by the system (e.g., embedding component 302) embeddings of the tokens. For example, as described above in reference to FIG. 7, embedding component 302 can receive the tokens after normalization and parameterization and generate embeddings for each of the tokens.

At 1310, method 1300 can comprise determining, by the system (e.g., embedding component 302), if the time series are multi-variate. If so (e.g., the time series is multivariate), method 1300 can proceed to step 1312. If not (e.g., the time series is not multivariate), method 1300 can proceed to step 1314.

At 1314, method 1300 can comprise sorting, by the system (e.g., ordering component 304), the tokens based on starting timestamps and pre-appending, by the system (e.g., embedding component 302) embeddings of channel identification tokens. The embeddings of the channel identification tokens can be pre-appended to each embedding of the tokens based on the channel from which the token originates.

At 1314, method 1300 can comprise feeding, by the system (e.g., embedding component 302), the embeddings into an LLMts (e.g., 116) as training data. For example, as described above in relation to FIGS. 8 and 9, the embeddings can be used as training data in order to train the LLMts 116 to make predictions of the next tokens.

System 102 provides technical improvements to hardware associated with system 102. For example, and methods described herein allow for more accurate training of an LLMts with fewer training cycles, in comparison to other methods, thereby decreasing the workload of a processing unit associated with the training process.

A practical application of system 102 is that it allows for training an LLMts on time series and improved generalization of the LLMts, in comparison to other methods. As described above, time series are sensitive to time shifts or changes in sampling rates, and therefore unreliable for training an LLMts. Accordingly, the systems and methods described herein enable creation of universal tokens of timeseries that can be applied to any timeseries that overcome the limitations of time series heterogeneity and LLMts training methods that prevent effective usage time series. For example, by normalizing and parameterizing the tokens, the tokens can comprise a uniform dimensionality that can enable creation of embeddings for training the LLMts. Additionally, by segmenting the time series based on local minima, the tokens can comprise any suitable length without constraints, enabling the embeddings and the LLMts to capture different resolutions and dynamics of each of the time series. Furthermore, the use of channel identification tokens and sorting of time series tokens enables training of an LLMts on multi-variate time series. An additional practical application of system 102 is that it allows for enhanced generalization of an LLMts with less training data, thereby reducing the computer storage requirements for training sets.

It is to be appreciated that system 102 can utilize various combination of electrical components, mechanical components, and circuitry that cannot be replicated in the mind of a human or performed by a human as the various operations that can be executed by system 102 and/or components thereof as described herein are operations that are greater than the capability of a human mind. For instance, the amount of data processed, the speed of processing such data, or the types of data processed by system 102 over a certain period of time can be greater, faster, or different than the amount, speed, or data type that can be processed by a human mind over the same period of time. According to several embodiments, system 102 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that system 102 can include information that is impossible to obtain manually by an entity, such as a human user. For example, the type, amount, and/or variety of information included in system 102 can be more complex than information obtained manually by an entity, such as a human user.

FIG. 14 and the following discussion are intended to provide a brief, general description of a suitable computing environment 1400 in which one or more embodiments described herein at FIGS. 1-13 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1400 contains an example of an environment for the execution of at least some of the computer code involved in performing the inventive methods, such as translation of an original source code based on a configuration of a target system by the universal time series tokenization code 1445. In addition to block 1445, computing environment 1400 includes, for example, computer 1401, wide area network (WAN) 1402, end user device (EUD) 1403, remote server 1404, public cloud 1405, and private cloud 1406. In this embodiment, computer 1401 includes processor set 1410 (including processing circuitry 1420 and cache 1421), communication fabric 1411, volatile memory 1412, persistent storage 1413 (including operating system 1422 and block 1445, as identified above), peripheral device set 1414 (including user interface (UI), device set 1423, storage 1424, and Internet of Things (IoT) sensor set 1425), and network module 1415. Remote server 1404 includes remote database 1430. Public cloud 1405 includes gateway 1440, cloud orchestration module 1441, host physical machine set 1442, virtual machine set 1443, and container set 1444.

COMPUTER 1401 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1430. As is well understood in the art of computer technology, and depending upon the technology, performance of a computer-implemented method can be distributed among multiple computers and/or between multiple locations. On the other hand, in this presentation of computing environment 1400, detailed discussion is focused on a single computer, specifically computer 1401, to keep the presentation as simple as possible. Computer 1401 can be located in a cloud, even though it is not shown in a cloud in FIG. 14. On the other hand, computer 1401 is not required to be in a cloud except to any extent as can be affirmatively indicated.

PROCESSOR SET 1410 includes one, or more, computer processors of any type now known or to be developed in the future. Processing circuitry 1420 can be distributed over multiple packages, for example, multiple, coordinated integrated circuit chips. Processing circuitry 1420 can implement multiple processor threads and/or multiple processor cores. Cache 1421 is memory that is located in the processor chip package(s) and is typically used for data or code that should be available for rapid access by the threads or cores running on processor set 1410. Cache memories are typically organized into multiple levels depending upon relative proximity to the processing circuitry. Alternatively, some, or all, of the cache for the processor set can be located “off chip.” In some computing environments, processor set 1410 can be designed for working with qubits and performing quantum computing.

Computer readable program instructions are typically loaded onto computer 1401 to cause a series of operational steps to be performed by processor set 1410 of computer 1401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1421 and the other storage media discussed below. The program instructions, and associated data, are accessed by processor set 1410 to control and direct performance of the inventive methods. In computing environment 1400, at least some of the instructions for performing the inventive methods can be stored in block 1445 in persistent storage 1413.

COMMUNICATION FABRIC 1411 is the signal conduction path that allows the various components of computer 1401 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1412 is any type of volatile memory now known or to be developed in the future. Examples include dynamic type random access memory (RAM) or static type RAM. Typically, the volatile memory is characterized by random access, but this is not required unless affirmatively indicated. In computer 1401, the volatile memory 1412 is located in a single package and is internal to computer 1401, but, alternatively or additionally, the volatile memory can be distributed over multiple packages and/or located externally with respect to computer 1401.

PERSISTENT STORAGE 1413 is any form of non-volatile storage for computers that is now known or to be developed in the future. The non-volatility of this storage means that the stored data is maintained regardless of whether power is being supplied to computer 1401 and/or directly to persistent storage 1413. Persistent storage 1413 can be a read only memory (ROM), but typically at least a portion of the persistent storage allows writing of data, deletion of data and re-writing of data. Some familiar forms of persistent storage include magnetic disks and solid-state storage devices. Operating system 1422 can take several forms, such as various known proprietary operating systems or open-source Portable Operating System Interface type operating systems that employ a kernel. The code included in block 1445 typically includes at least some of the computer code involved in performing the inventive methods.

PERIPHERAL DEVICE SET 1414 includes the set of peripheral devices of computer 1401. Data communication connections between the peripheral devices and the other components of computer 1401 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1423 can include components such as a display screen, speaker, microphone, wearable devices (such as goggles and smart watches), keyboard, mouse, printer, touchpad, game controllers, and haptic devices. Storage 1424 is external storage, such as an external hard drive, or insertable storage, such as an SD card. Storage 1424 can be persistent and/or volatile. In some embodiments, storage 1424 can take the form of a quantum computing storage device for storing data in the form of qubits. In embodiments where computer 1401 is required to have a large amount of storage (for example, where computer 1401 locally stores and manages a large database) then this storage can be provided by peripheral storage devices designed for storing large amounts of data, such as a storage area network (SAN) that is shared by multiple, geographically distributed computers. IoT sensor set 1425 is made up of sensors that can be used in Internet of Things applications. For example, one sensor can be a thermometer and another sensor can be a motion detector.

NETWORK MODULE 1415 is the collection of computer software, hardware, and firmware that allows computer 1401 to communicate with other computers through WAN 1402. Network module 1415 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1415 are performed on the same physical hardware device. In other embodiments (for example, embodiments that utilize software-defined networking (SDN)), the control functions and the forwarding functions of network module 1415 are performed on physically separate devices, such that the control functions manage several different network hardware devices. Computer readable program instructions for performing the inventive methods can typically be downloaded to computer 1401 from an external computer or external storage device through a network adapter card or network interface included in network module 1415.

WAN 1402 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1403 is any computer system that is used and controlled by an end user (for example, a customer of an enterprise that operates computer 1401) and can take any of the forms discussed above in connection with computer 1401. EUD 1403 typically receives helpful and useful data from the operations of computer 1401. For example, in a hypothetical case where computer 1401 is designed to provide a recommendation to an end user, this recommendation would typically be communicated from network module 1415 of computer 1401 through WAN 1402 to EUD 1403. In this way, EUD 1403 can display, or otherwise present, the recommendation to an end user. In some embodiments, EUD 1403 can be a client device, such as thin client, heavy client, mainframe computer and/or desktop computer.

REMOTE SERVER 1404 is any computer system that serves at least some data and/or functionality to computer 1401. Remote server 1404 can be controlled and used by the same entity that operates computer 1401. Remote server 1404 represents the machine(s) that collect and store helpful and useful data for use by other computers, such as computer 1401. For example, in a hypothetical case where computer 1401 is designed and programmed to provide a recommendation based on historical data, then this historical data can be provided to computer 1401 from remote database 1430 of remote server 1404.

PUBLIC CLOUD 1405 is any computer system available for use by multiple entities that provides on-demand availability of computer system resources and/or other computer capabilities, especially data storage (cloud storage) and computing power, without direct active management by the scale. The direct and active management of the computing resources of public cloud 1405 is performed by the computer hardware and/or software of cloud orchestration module 1441. The computing resources provided by public cloud 1405 are typically implemented by virtual computing environments that run on various computers making up the computers of host physical machine set 1442, which is the universe of physical computers in and/or available to public cloud 1405. The virtual computing environments (VCEs) typically take the form of virtual machines from virtual machine set 1443 and/or containers from container set 1444. It is understood that these VCEs can be stored as images and can be transferred among and between the various physical machine hosts, either as images or after instantiation of the VCE. Cloud orchestration module 1441 manages the transfer and storage of images, deploys new instantiations of VCEs and manages active instantiations of VCE deployments. Gateway 1440 is the collection of computer software, hardware and firmware allowing public cloud 1405 to communicate through WAN 1402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1406 is similar to public cloud 1405, except that the computing resources are only available for use by a single enterprise. While private cloud 1406 is depicted as being in communication with WAN 1402, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1145 and private cloud 1146 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A computer system for facilitating a process to build a universal vocabulary of tokens from time series for large language model training, the computer system comprising:
one or more processors;
one or more computer readable storage media; and
program instructions stored on the one or more computer readable storage media, the program instructions executable by the processor resulting in the computer system to perform one or more functions, the functions comprising:
segment one or more time series based on local minima of the one or more time series; and
generate a universal vocabulary of tokens.

2. The computer system of claim 1, wherein generating the universal vocabulary of tokens comprises normalizing and parameterizing the tokens.

3. The computer system of claim 2, wherein normalizing the tokens comprises extracting a plurality of vertical or a plurality of horizontal scales of the tokens.

4. The computer system of claim 2, wherein parameterizing the tokens comprises approximating the tokens based on a continuous basis function.

5. The computer system of claim 1, further comprising functions to:
generate n-dimensional embeddings of the tokens.

6. The computer system of claim 5, further comprising functions to:
label the tokens with a channel identification token before inputting the tokens into the large language model.

7. The system of claim 1, further comprising functions to:
sort the tokens based on a respective timestamp of the tokens.

8. The system of claim 5, further comprising functions to:
generate the n-dimensional embeddings as orthogonal random features.

9. A computer-implemented method for facilitating a process to build a universal vocabulary of tokens from time series for large language model training, the computer-implemented method comprising:
segmenting, by a processor, one or more time series based on local minima of the one or more time series; and
generating, by the processor, a universal vocabulary of tokens.

10. The computer-implemented method of claim 9, wherein generating the universal vocabulary of tokens comprises:
normalizing, by the processor, the tokens; and
parameterizing, by the processor, the tokens.

11. The computer-implemented method of claim 10, wherein normalizing the tokens comprises:
extracting, by the processor, a plurality of vertical or a plurality of horizontal scales of the tokens.

12. The computer-implemented method of claim 10, wherein parameterizing the tokens comprises:
approximating, by the processor, the tokens based on a continuous basis function.

13. The computer-implemented method of claim 9, further comprising:
generating, by the processor, n-dimensional embeddings of the tokens.

14. The computer-implemented method of claim 13, further comprising:
labeling, by the processor, the tokens with a channel identification token before inputting the tokens into the large language model.

15. The computer-implemented method of claim 9, further comprising:
sorting, by the processor, the tokens based on a respective timestamp of the tokens for training the large language model.

16. The computer-implemented method of claim 13, further comprising:
generating, by the processor, the n-dimensional embeddings as orthogonal random features.

17. A computer program product for facilitating a process to build a universal vocabulary of tokens from time series for large language model training, the computer program product comprising a one or more computer readable storage media and program instructions, executable by a processor, stored on the computer readable storage media, the program instructions comprising:
program instructions to segment one or more time series based on local minima of the one or more time series; and
program instructions to generate a universal vocabulary of tokens.

18. The computer program product of claim 17, wherein generating the universal vocabulary of tokens further comprises program instructions to normalize and parameterize the tokens.

19. The computer program product of claim 18, wherein normalizing the tokens further comprises program instructions to extract a plurality of vertical or a plurality of horizontal scales of the tokens.

20. The computer program product of claim 18, wherein parameterizing the tokens further comprises program instruction to approximate the tokens based on a continuous basis function.
